(19) United States
(12) Patent Application Publication
(10) Pub. No.: US 2026/0177172 A1
(43) Pub. Date: Jun. 25, 2026

(54) CONCEALED CONNECTOR STRUCTURE, AND APPLICATION AND USE METHOD THEREOF

(71) Applicant: Apexstone Amoy Marble & Granite, Xiamen (CN)

(72) Inventor: Pengcheng Wu, Xiamen (CN)

(21) Appl. No.: 19/536,168

(22) Filed: Feb. 10, 2026

(30) Foreign Application Priority Data
Apr. 3, 2025 (CN) 202510419144 .9

(51) Int. Cl. F16L 21/03; H01R 13/64; H01R 24/38

(52) U.S. Cl. CPC F16L 21/03; H01R 13/64; H01R 24/38

(57) ABSTRACT

A concealed connector structure, and an application and a use method thereof are provided. The concealed connector structure includes an axial connector and at least one channel each capable of being threadedly connected with a fastening screw and provided on the axial connector, where the channel extends radially through the axial connector, to allow the fastening screw to be inserted through a first end of the channel and extend out from a second end of the channel.

### CROSS REFERENCE TO RELATED APPLICATIONS

The present disclosure claims the priority to the Chinese patent application with the filing No. 202510419144.9, entitled “CONCEALED CONNECTOR STRUCTURE, AND APPLICATION AND USE METHOD THEREOF” and filed on Apr. 3, 2025 with the Chinese Patent Office, the contents of which are incorporated herein by reference in their entirety.

### TECHNICAL FIELD

The present disclosure relates to a connecting component for pipe fittings, and particularly to a concealed connector structure and an application and a use method thereof.

### BACKGROUND ART

Industrial products and daily necessities often involve axial connection or extension of pipe fittings with the same cross-section or irregularly-shaped pipe fittings with different cross-sectional shapes. Typical examples include clothes rail formed of connected two circular pipes with the same outer diameter and wall thickness.

For firm reliable connection of pipe fittings, welding is the preferred method. However, most environments do not have the conditions for welding, and weld seams need to be ground after welding for aesthetic purposes, which wastes energy and increases labor costs, and the biggest problem is that it is inconvenient to disassemble after welding. For irregularly-shaped pipe fittings with different cross-sections, direct welding is neither convenient nor reliable.

In addition, the currently found Chinese patent No. CN102192372B entitled “Pipe Fitting Connector and Disassembly Tool for the Pipe Fitting Connector” includes a cylindrical body and a sleeve ring sleeved over the body, where the sleeve ring is threadedly connected to the body, the disassembly tool includes a housing capable of positioning the body, the housing is provided thereinside with a transmission mechanism and the transmission mechanism has the input end and the output end located at two sides of the housing respectively, and after the housing fixes the body, the power transmitted from the output end of the transmission mechanism can drive the sleeve ring to rotate relative to the body. While this patent solves the problems of extremely inconvenient operation and extremely low efficiency of existing pipe fitting connectors and disassembly tools for the pipe fitting connectors, it does not facilitate the connection of pipe fittings.

The found Chinese patent application CN107131366A entitled “Pipe Fitting Connection Structure and Connection Structure for Stainless Steel Pipe Fitting and Copper Pipe” includes a connecting part (24) and a connecting sleeve (1), where the connecting part is made of a stainless steel material, and the connecting sleeve is made of a copper material, the connecting sleeve (1) includes a sleeve body part (11), the sleeve body part (11) is at least mostly located inside the connecting part (24), and the outer wall (111) of the sleeve body part (11) fits with the inner wall (211) of the connecting part (24); the inner wall of the connecting part (24) fitting with the sleeve body part (11) is provided with a stepped surface (22) on the inner side of the connecting sleeve, the connecting sleeve has a positioning step portion relatively close to the stepped surface, and there is an axial distance between the stepped surface of the connecting part and the positioning step portion of the connecting sleeve; the connecting part is fixed to the connecting sleeve by welding, and there is solder in the space between the outer wall (111) of the sleeve body part (11) and the inner wall (211) of the portion of the connecting part (24) fitting with the sleeve body part (11). The connection structure of the pipe fitting in this patent is relatively complex and difficult to process and produce.

### SUMMARY

In view of the above-mentioned problems, the purpose of the present disclosure is to provide a concealed connector structure and an application and a use method thereof. The concealed connector structure is reasonably designed and facilitates convenient production and use.

The present disclosure is implemented using the following solutions.

The concealed connector structure of the present disclosure is characterized by including an axial connector and at least one channel capable of being threadedly connected with a fastening screw and provided on the axial connector, where the channel extends radially through the axial connector, so as to allow the fastening screw to be inserted through a first end of the channel and extend out from a second end of the channel.

Preferably, the cross-section of the axial connector is the same in the entire length direction, and the cross-section is circular, square, or elliptical.

Preferably, the axial connector has two or more different cross-sections or dimensions in the entire length direction, and the cross-sections are circular, square, or elliptical.

Preferably, the axial connector is a hollow rod body, where a wall body of a side of the hollow rod body is provided with at least one threaded hole, and a wall body of a side opposite to the at least one threaded hole is provided with at least one through hole configured for allowing the at least one fastening screw to pass therethrough, and the at least one threaded hole and the at least one through hole constitute the at least one channel extending through the axial connector.

Preferably, the axial connector is a hollow rod body, where wall bodies of two sides of the hollow rod body are provided with identical threaded holes, any two corresponding threaded holes of the wall bodies of the two sides are coaxial and constitute one of the at least one channel extending through the axial connector.

Preferably, the axial connector is a solid rod body, the solid rod body is provided with at least one threaded hole or at least one threaded countersunk hole extending through the axial connector, and the at least one threaded hole or the at least one threaded countersunk hole constitute the at least one channel extending through the axial connector.

Preferably, the axial connector is provided with several groups of channels in the circumferential direction, and/or the axial connector is provided with several groups of channels in the axial direction.

Preferably, two ends of the axial connector are each provided with one channel, and fastening screws are threadedly connected inside the two channels, external connecting pipes are respectively sleeved over the two ends of the axial connector, and the fastening screws extend out from the second ends of the channels and abut against the inner wall surfaces of the external connecting pipes.

Preferably, an arc-shaped sheet is provided between the inner wall surface of the external connecting pipe and the outer peripheral surface of the axial connector, and the end of the fastening screw extending out from the second end of the channel abuts against the inner wall surface of the arc-shaped sheet, and the outer peripheral surface of the arc-shaped sheet fits with (contacts) the inner wall surface of the external connecting pipe.

Preferably, a sealing ring is provided between the outer peripheral surface of the arc-shaped sheet and the inner wall surface of the external connecting pipe.

Preferably, the cross-sectional shapes and dimensions of the external connecting pipes at the two ends of the axial connector are the same or different, and the cross-sectional shapes and dimensions of the corresponding two ends of the axial connector are matched correspondingly.

Preferably, the external connecting pipes sleeved over the two ends of the axial connector are provided at an internal, and the axial connector is provided with at least one intermediate threaded hole located between the two external connecting pipes, a stud is inserted into the intermediate threaded hole, and the stud passes through a through hole of a second outer pipe located above the axial connector.

Preferably, the outer tube is sleeved over the outer periphery of the axial connector, and the outer pipe is provided with at least one counterbore, the at least one counterbore is directly opposite to the first end or the second end of the at least one channel provided on the axial connector, but no counterbore is provided at the position directly opposite to the fastening screw that extends out from the second end of the at least one channel.

Preferably, a to-be-installed component with a threaded through hole is provided beside the outer pipe, and a stud is inserted into the threaded through hole and the threaded hole to realize fastening of the to-be-installed component to the outer pipe.

Preferably, the axial connector has one end open and one end closed, and a screw is provided penetrating through the closed end, the axial connector is installed at the end of a to-be-connected pipe. The to-be-connected pipe is provided with an external counterbore that is directly opposite to the channel to facilitate the fastening screw entering the channel, a connected pipe with a through hole for allowing the screw to pass therethrough is provided beside the to-be-connected pipe, and a nut for fastening the screw is provided inside the connected pipe.

Preferably, non-circular grooves are provided at corresponding positions of the contact surfaces of the connected pipe and the to-be-connected pipe, and a gasket matching the shapes of the non-circular grooves is provided in the non-circular grooves.

Through an axial connector with simple structure, low cost, and standardized manufacturing and its specific installation method which uses a manner similar to internal expansion to achieve concealed fixing, the present disclosure greatly improves the convenience, firmness, reliability, and aesthetics of pipe fitting connections. Furthermore, it overcomes the drawback that any previous connection methods cannot overcome, i.e., the pipe fittings with irregularly-shaped cross sections are connected only by flanges.

### BRIEF DESCRIPTION OF DRAWINGS

The present disclosure will be further illustrated below in conjunction with the drawings.

FIG. 1 is a section view of one embodiment of an axial connector;

FIG. 2 is a left view of an embodiment of the axial connector;

FIG. 3 is a section view of another embodiment of the axial connector;

FIG. 4 is a section view of another embodiment of the axial connector;

FIG. 5 is a section view of another embodiment of the axial connector;

FIG. 6 is a section view of another embodiment of the axial connector;

FIG. 7 is a left view of an embodiment of the axial connector;

FIG. 8 is a section view of another embodiment of the axial connector;

FIG. 9 is a cross-sectional view of one embodiment of the axial connector;

FIG. 10 is a section view of a first application embodiment of the axial connector;

FIG. 11 is a section view of the first application embodiment of the axial connector, in which arc-shaped sheets and sealing rings are added;

FIG. 12 is a cross-sectional view of FIG. 11;

FIG. 13 is a section view of a second application embodiment of the axial connector;

FIG. 14 is a cross-sectional view of FIG. 13;

FIG. 15 is a section view of the first application embodiment of the axial connector applied to external connecting pipes with different cross-sections;

FIG. 16 is a cross-sectional view of FIG. 15;

FIG. 17 is a section view of the second application embodiment of the axial connector applied to external connecting pipes with different cross-sections;

FIG. 18 is a three-dimensional schematic view of the external connecting pipe in FIG. 17;

FIG. 19 is a section view of a third application embodiment of the axial connector;

FIG. 20 is a section view of the fourth application embodiment of the axial connector (for the case where the axis of the handrail connecting hole is provided inclined relative to the axis of the axial connector);

FIG. 21 is a section view of the fourth application embodiment of the axial connector (for the case where the axis of the handrail connecting hole is provided perpendicular to the axis of the axial connector);

FIG. 22 is a section view of the fifth application embodiment of the axial connector;

FIG. 23 is a cross-sectional view of the sixth application embodiment of the axial connector (for the outer pipe with a circular cross-section);

FIG. 24 is a cross-sectional view of the sixth application embodiment of the axial connector (for the outer pipe with a rectangular cross-section);

FIG. 25 is a cross-sectional view of the sixth application embodiment of the axial connector (with multiple channels around the circumference);

FIG. 26 is a cross-sectional view of the sixth application embodiment of the axial connector (for connection with a to-be-installed component);

FIG. 27 is a perspective view of a sixth application embodiment of the axial connector (with multiple channels around the circumference);

FIG. 28 is a perspective view of one embodiment of the axial connector (with multiple channels around the circumference and in the axial direction);

FIG. 29 is a perspective view of an application embodiment of the axial connector of FIG. 28 (with multiple channels around the circumference and in the axial direction);

FIG. 30 is a section view of the seventh application embodiment of the axial connector (for the case where the connected pipe is a circular pipe);

FIG. 31 is a section view of the seventh application embodiment of the axial connector (for the case where the connected pipe is a square pipe);

FIG. 32 is a cross-sectional view of FIG. 31; and

FIG. 33 is a cross-sectional view of the sixth application embodiment of the axial connector in one application scenario.

### DETAILED DESCRIPTION OF EMBODIMENTS

The present disclosure will be further illustrated below in conjunction with the drawings and embodiments.

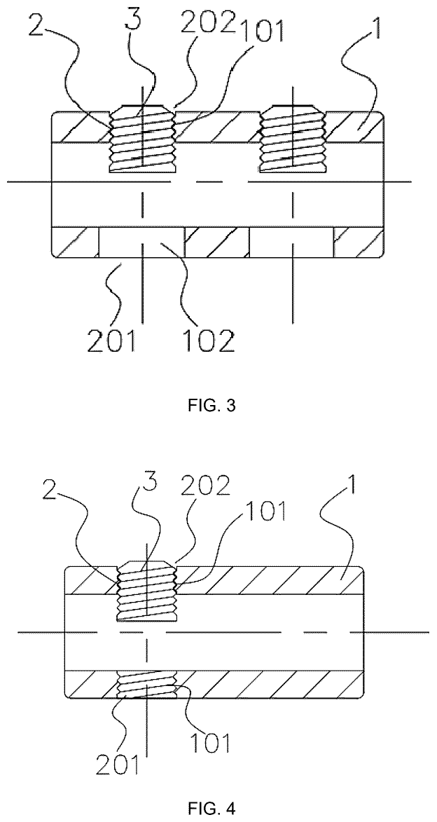

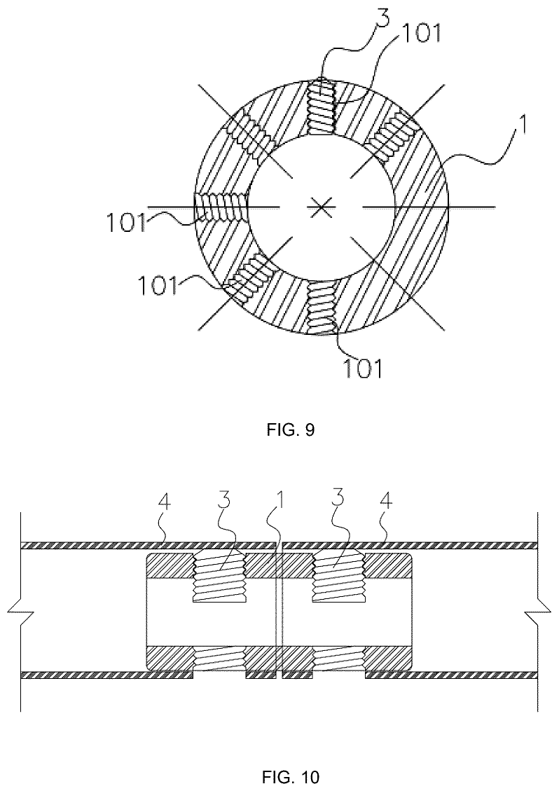

The concealed connector structure of the present disclosure includes an axial connector 1 and at least one channel 2 capable of being threadedly connected with a fastening screw 3 and provided on the axial connector (the channel may be threaded along its entire length or threaded in a local segment). The axial connector is provided with one, two, three, or more groups of channels in its circumferential direction, and/or the axial connector is provided with one, two, three, or more groups of channels in its axial direction; that is, the axial connector is provided with one, two, three, or more groups of channels in its circumferential direction (as shown in FIGS. 9, 23, 24, 25, etc., two or more groups are provided around the circumference to increase the fastening strength), and the axial connector is provided with one, two, three, or more groups of channels in its axial direction (as shown in FIGS. 3, 5, 10, 11, 28, 29, etc., two or more groups are provided in the axial direction to increase the fastening strength); or, the axial connector is provided with one, two, three or more groups of channels in the circumferential direction, or the axial connector is provided with one, two, three or more groups of channels in the axial direction.

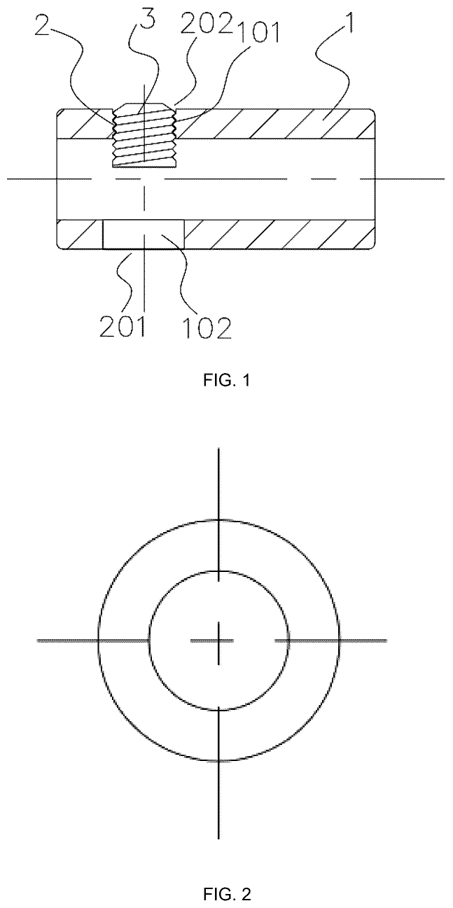

The axis line of the channel and the axis line of the axial connector may be provided perpendicular to each other (as shown in FIGS. 1, 3, 4, 5, etc.) or may also be provided inclinedly (i.e., the axis line of the channel and the axis line of the axial connector may form an angle of 60-90 degrees), and at the same time, the axis line of the channel may intersect or not intersect the axis line of the axial connector.

In the above, the cross-section of the axial connector is the same along its entire length, and the cross-section is circular, square, elliptical, or of other shapes; or the axial connector has two or more different cross-section shapes or dimensions along its entire length (to match/adapt to the cross-section shapes and dimensions of different external connecting pipes), and the cross-sections are circular, square, elliptical, or of other shapes, i.e., a stepped shape with variable cross-sections along its length.

The channel allows the fastening screw 3 threadedly connected thereto to be inserted through the first end 201 of the channel 2 and extend out from the second end 202 of the channel (i.e., the fastening screw may be extended out from the second end 202 of the channel after being screwed into the channel). That is, the channel may be threaded along its entire length (as shown in FIG. 8) or threaded in a local segment (as shown in FIGS. 1, 3, 4, etc.).

The fastening screw 3 is a commercially available part, which has threads on its outer periphery and the end surface of which is provided with an internal hexagon countersunk hole or through hole. An internal hexagon wrench is used to adjust the thread engagement depth of the fastening screw 3 within the channel 2 and the length of the portion of the fastening screw 3 extending out from the second end 202 of the channel.

In one specific embodiment (as shown in FIGS. 1, 2, and 3), for the case where the axial connector 1 is a hollow rod body (i.e., a pipe body with a certain wall thickness), the wall body of one side of the hollow rod body is provided with threaded hole(s) 101, and the wall body of the side opposite to the threaded hole(s) is provided with through hole(s) 102 for allowing the fastening screw(s) to pass therethrough (i.e., the diameter of the through hole 102 may be slightly larger than that of the fastening screw). The threaded hole and the through hole constitute the channel extending through the axial connector. During processing, the threaded hole 101 and the through hole 102 may be machined in different machining processes, or obtained by machining with different tools in the same machining process.

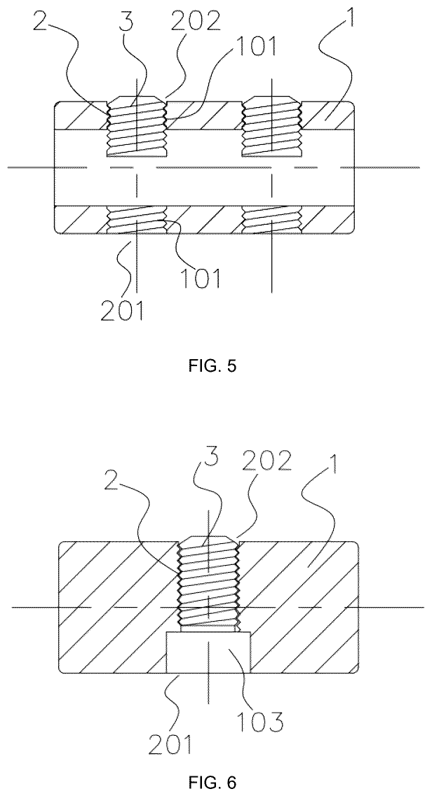

In one specific embodiment (a preferred embodiment, as shown in FIGS. 4 and 5), for the case where the axial connector 1 is a hollow rod body (i.e. a pipe body with a certain wall thickness), wall bodies of two sides of the hollow rod body are provided with identical threaded holes 101, two corresponding threaded holes of the wall bodies of the two sides are coaxial and constitute the channel extending through the axial connector. That is, during machining, the threaded holes on the wall bodies of the two sides may be machined in one machining process.

For the hollow rod body, a central threaded channel 105 may be provided in the central hole thereof to add a connection position (as shown in FIG. 28).

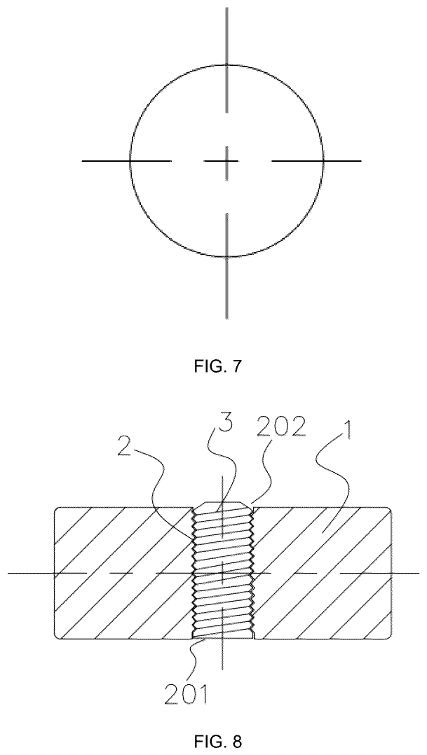

In one specific embodiment, for the case where the axial connector is a solid rod body (as shown in FIGS. 6, 7, and 8), the solid rod body is provided with a threaded hole or threaded countersunk hole 103 extending through the axial connector, and the threaded hole or threaded countersunk hole constitutes the channel extending through the axial connector.

Several application embodiments of the above-mentioned axial connector will be described below.

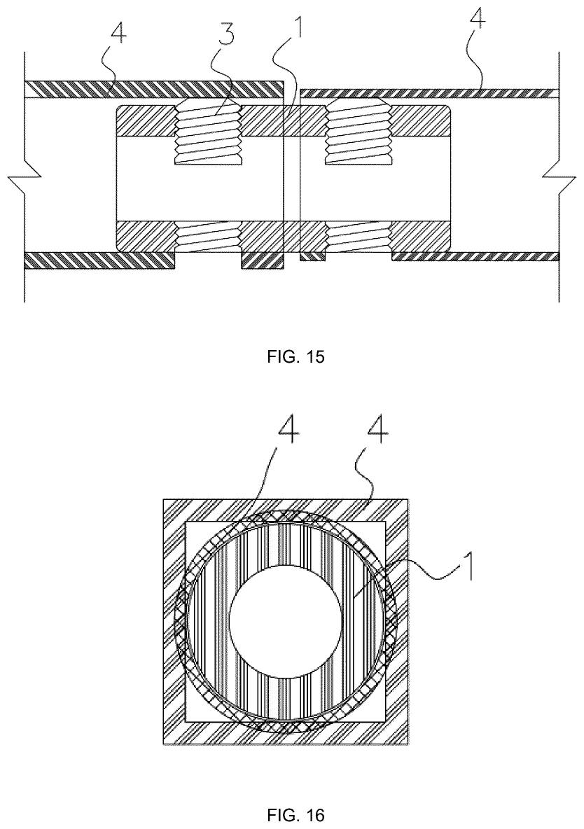

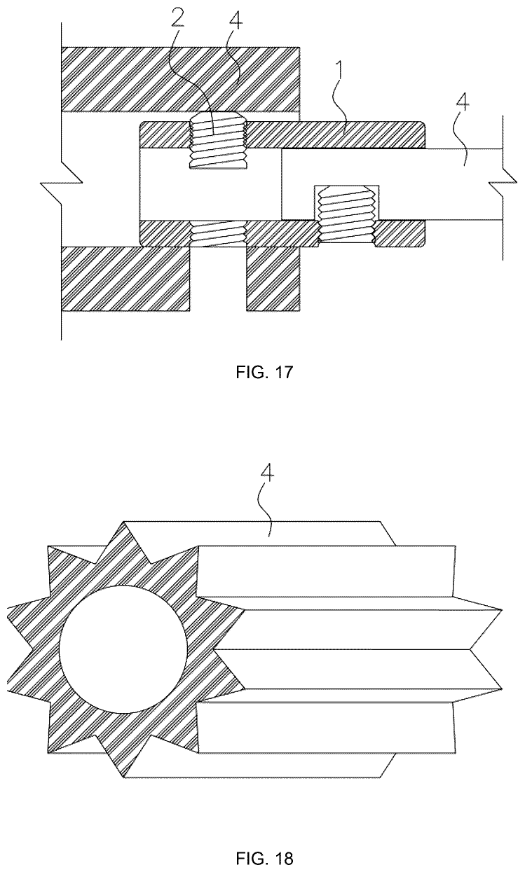

In the above, in the first application embodiment (as shown in FIG. 10, showing axial extension connection of two pipe fittings), the two ends of the axial connector 1 are provided with the channels 2, and fastening screws 3 are threadedly connected inside the two channels. External connecting pipes 4 are respectively sleeved over the two ends of the axial connector (the cross-sectional shapes and dimensions of the two external connecting pipes 4 may be the same or different, and the cross-section of the external connecting pipe 4 may be circular, square or elliptical, etc., as shown in FIGS. 15, 16, 17 and 18, the cross-section shapes and dimensions of the corresponding two ends of the axial connector 1 may be correspondingly matched with those of the external connecting pipes. The external connecting pipes 4 and the axial connector 1 may be in transition fit or clearance fit, and the external connecting pipes are each provided with a counterbore at the position opposite to the first end of the channel, so as to facilitate inserting of the internal hexagon wrench). The fastening screws 3 in the two channels both extend out from the second ends 202 of the channels and abut against the inner wall surfaces of the external connecting pipes 4.

The fastening screws 3 in the two channels abut against the inner wall surfaces of the external connecting pipes 4, so as to achieve the fastening of the external connecting pipes 4 to the axial connector 1. The cross-sections of the two external connecting pipes 4 may be flat surfaces or of other shapes that can fit/complement each other.

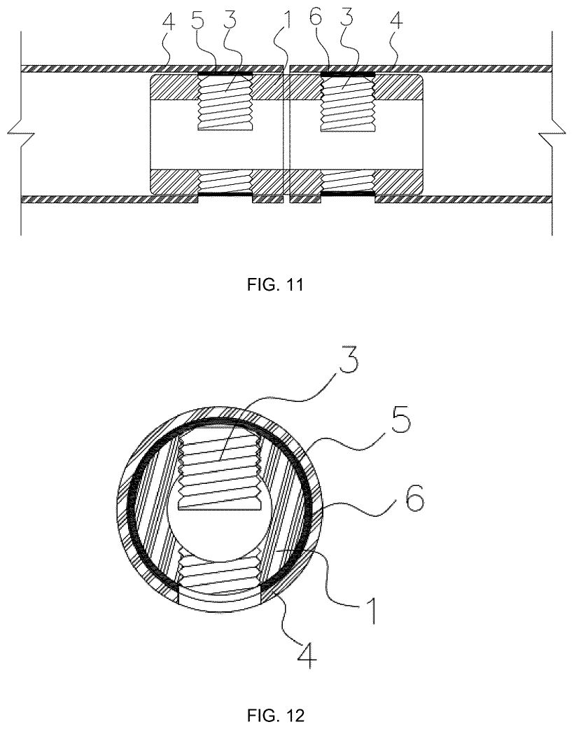

As shown in FIGS. 11 and 12, in order to avoid that the thin-walled external connecting pipe 4 deforms due to the pushing force applied by the end of the fastening screw 3, an arc-shaped sheet 5 is provided between the inner wall surface of the external connecting pipe and the outer peripheral surface of the axial connector (the arc-shaped sheet 5 may be a metal sheet or a plastic sheet, and the shape of the arc-shaped sheet 5 may match the inner wall surface of the external connecting pipe; and the arc-shaped sheet 5 may be a three-quarter, one-third, or one-half annular sheet). The end of the fastening screw extending out from the second end of the channel abuts against the inner wall surface of the arc-shaped sheet, and the outer peripheral surface of the arc-shaped sheet fits with the inner wall surface of the external connecting pipe. Due to the arrangement of the arc-shaped sheet 5, the force-bearing area of the inner wall surface of the external connecting pipe is greatly increased, avoiding deformation of the external connecting pipe 4 generated due to localized force.

Further, a sealing ring 6 may be provided between the outer peripheral surface of the arc-shaped sheet and the inner wall surface of the external connecting pipe (to adapt to situations requiring watertightness or airtightness). The sealing ring 6 may be made of a material such as rubber, and certainly, the sealing ring 6 is provided with a hole for avoiding the channel.

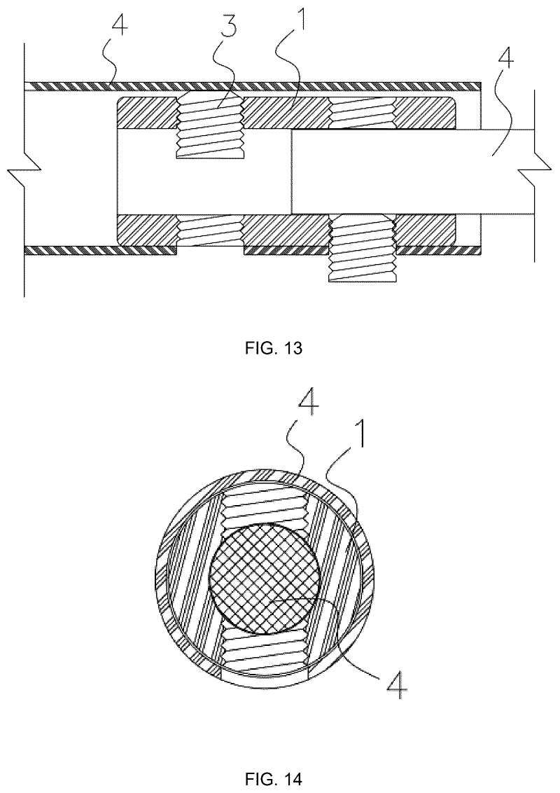

In the above, for the second application embodiment (as shown in FIGS. 13 and 14), the second application embodiment differs from the first application embodiment in that one external connecting pipe of the two external connecting pipes has a smaller diameter. At this time, one external connecting pipe is sleeved over the outer periphery of the axial connector 1 (to abut against the inner wall surface of the external connecting pipe 4 through a fastening screw 3 in one channel), and the other external connecting pipe is inserted into the central hole of the axial connector 1 (to abut against the inner wall surface of the external connecting pipe 4 through a fastening screw 3 in the other channel).

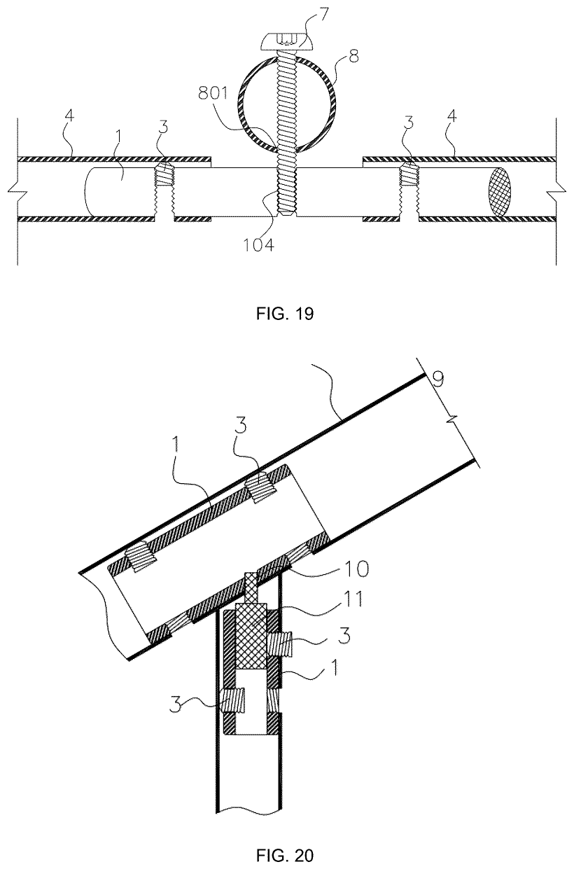

In the above, for the third application embodiment (as shown in FIG. 19), in this embodiment, the external connecting pipes 4 sleeved over the two ends of the axial connector respectively are provided at an interval. The axial connector is provided with intermediate threaded hole(s) 104 located between the two external connecting pipes (there may be one or more intermediate threaded holes 104, and each additional one provides an additional connection channel). A stud 7 passes through the intermediate threaded hole. The stud 7 passes through the through hole 801 of the second outer pipe 8 located above the axial connector. Through this structure, the axial connection of the two external connecting pipes and the connection with the second outer pipe 8 may be realized.

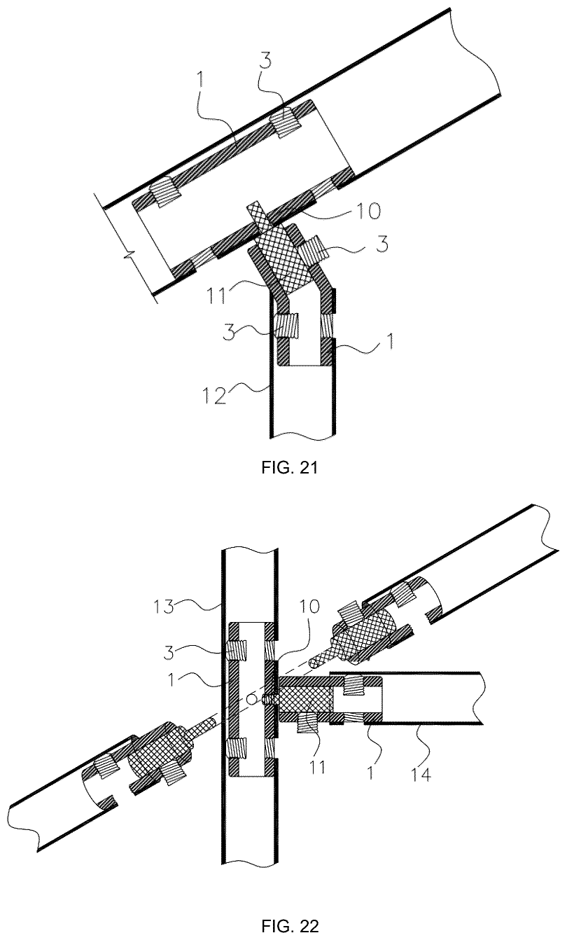

In the above, for the fourth application embodiment (as shown in FIGS. 20 and 21), this embodiment involves applying an axial connector to the handrail of the staircase, where the axial connector 1 is installed in the inner hole of the tubular handrail 9. The fastening screw 3 in the channel of the axial connector 1 abuts against the inner wall surface of the handrail 9. One side of the handrail 9 is provided with a counterbore corresponding to the channel, facilitating an inner hexagon wrench passing through the counterbore and entering the channel to rotate the fastening screw 3 (for reliable fastening, the axial connector 1 is provided with two channels, and fastening screws 3 are installed in the two channels to abut against the handrail 9).

The handrail and the axial connector are provided with a connecting hole 10 for being threadedly connected to the upper end of a column head screw 11 (the axis of the connecting hole 10 may be perpendicular or inclined to the axis of the handrail, for example, FIG. 20 shows inclined arrangement—a completely concealed form, and FIG. 21 shows perpendicular arrangement—a partially exposed form, where for the bent axial connector 1 as shown in FIG. 21, its constituent axes may be located in a same plane, or may be located in different planes, and the axes may be either straight or curved). A vertical pipe 12 is provided on the step of the staircase. A second axial connector is provided in the upper end body of the vertical pipe 12. The second axial connector is provided with two channels. Fastening screws 3 are connected in the two channels, where one fastening screw 3 abuts against the inner wall surface of the vertical pipe 12, and the other fastening screw 3 abuts against the outer periphery of the lower end of the column head screw 11.

In the above, for the fifth application embodiment (as shown in FIG. 22), this embodiment involves applying the axial connector to the interlocking connection of multiple pipe fittings, where the axial connector 1 is installed in the inner hole of a central pipe 13. The fastening screws 3 in the two channels of the axial connector 1 abut against the inner wall surface of the central pipe 13. At the same time, the central pipe 13 and the axial connector 1 are provided with several connecting holes 10 for being threadedly connected to one ends of the column head screws 11. The outer periphery of the central pipe 13 is provided with several side pipes 14. A second axial connector is provided in the end body of the side pipe 14. The second axial connector is provided with two channels, and fastening screws 3 are connected in the two channels, where one fastening screw 3 abuts against the inner wall surface of the side pipe 14, and the other fastening screw 3 abuts against the outer periphery of the other end of the column head screw 11. In this embodiment, the side pipe 14 and the central pipe 13 may be connected either vertically or inclinedly.

In this embodiment, the connection of three-way or even multi-way pipe fittings may be very conveniently achieved through combination of the connectors, that is, three-dimensional five-way connection is achieved as shown in the figure.

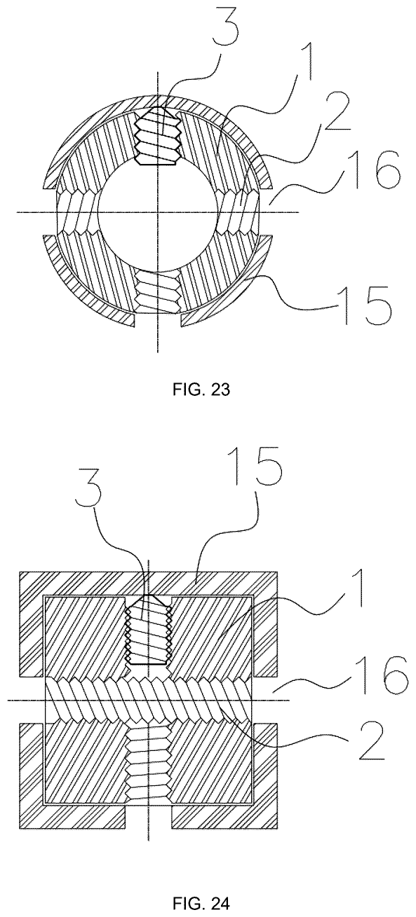

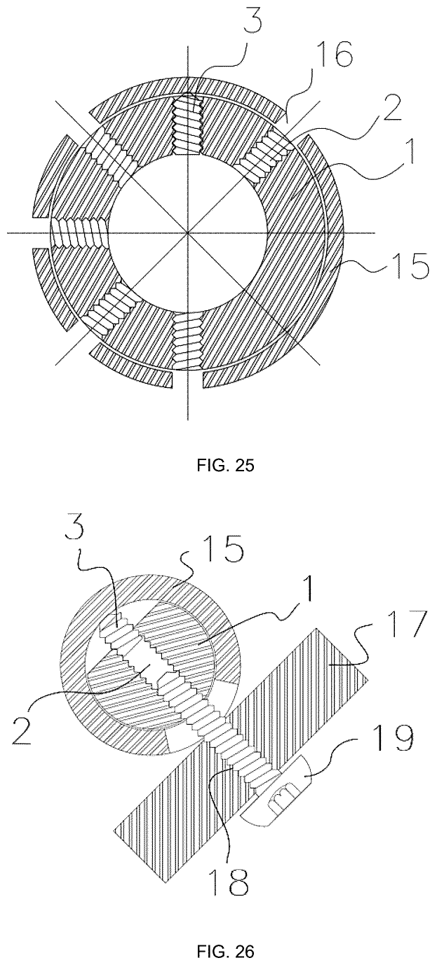

In the above, for the sixth application embodiment, the outer pipe 15 is sleeved over the outer periphery of the axial connector 1 (the cross-section of the out pipe 15 may be circular, square, or elliptical, etc., and the outer pipe may be a pipe or profile, etc. The outer contour shape of the axial connector 1 and the inner surface shape of the outer pipe 15 may match or be not completely identical, as long as at least local fit is ensured, so as to ensure that it does not move inside the outer pipe). The outer pipe is provided with several counterbores 16 (the diameter of the counterbore is slightly larger than the diameter of the channel 2). The counterbores 16 are directly opposite to the first ends or the second ends of the channels 2 provided on the axial connector, but no counterbore is provided at the position directly opposite to the fastening screw that extends out from the second end of the channel. That is, as shown in FIGS. 23-25, the axial connector 1 has two channels in its cross-section and three counterbores are provided correspondingly (as shown in FIGS. 23 and 24, the threads of the three counterbores corresponding to the channels can be used to connect other workpieces), or the axial connector 1 has four channels in its cross-section and five counterbores are provided correspondingly (as shown in FIG. 25, the threads of the five counterbores corresponding to the channels can be used to connect other workpieces).

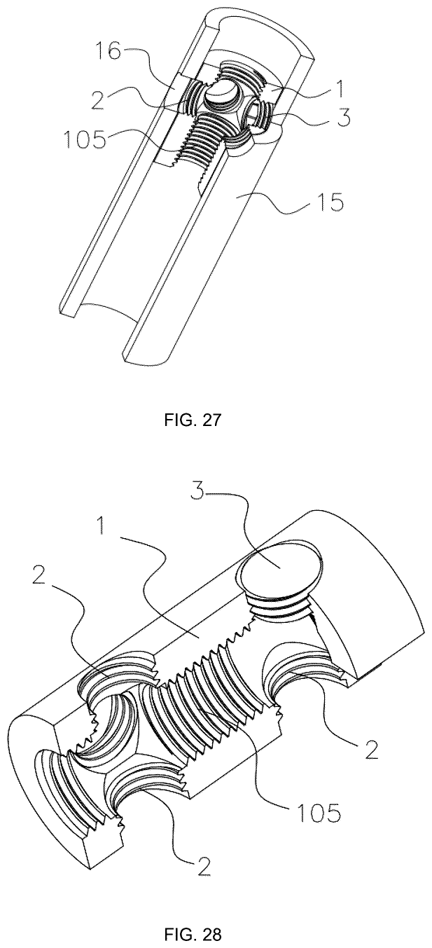

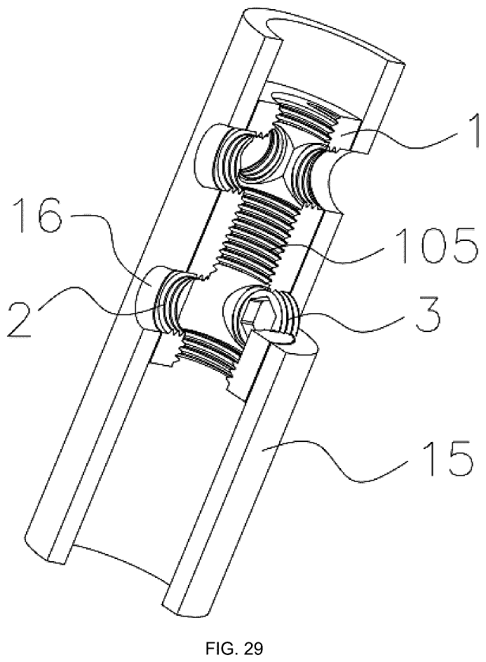

To increase connection stations, a central threaded channel 105 is provided in the central hole of the hollow axial connector 1 (i.e., tubular), a bolt may be connected in the central threaded channel 105, as shown in FIGS. 27-29. As shown in FIG. 27, 5 threaded connection stations are provided, and as shown in FIG. 29, 7 threaded connection stations are provided, thereby expanding the installation stations.

The specific application structure is as shown in FIG. 26. A to-be-installed component 17 (which may be a plate or a pipe) with a threaded through hole 18 is provided beside the outer pipe 15. A stud 19 is inserted into the threaded through hole 18 and the threaded hole (i.e., the channel 2) to achieve the fastening of the to-be-installed component 17 to the outer pipe 15, where a local segment of the threaded hole is used to be threadedly connected to the fastening screw 3, and a local segment of the threaded hole is used to be threadedly connected to the stud 19.

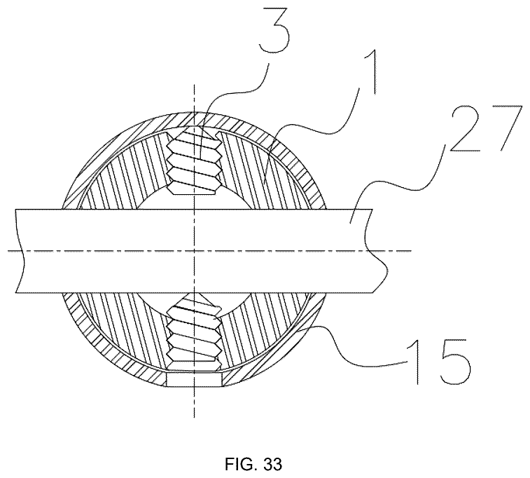

In this application embodiment, it may also be applied to the vertical connection of two pipe fittings (outer pipe 15 and through rod 27) (as shown in FIG. 33). The outer pipe 15 is sleeved over the outer periphery of the axial connector 1 (the cross-section of the outer pipe 15 may be circular, square, or elliptical, etc., and the outer pipe may be a pipe or profile, etc. The outer contour shape of the axial connector 1 and the inner surface shape of the outer pipe 15 may match or be not completely identical, as long as at least local fit is ensured, so as to ensure that it does not move inside the outer pipe). The through rod 27 penetrates through the outer pipe 15 and the axial connector 1 in the vertical direction. The first fastening screw 3 in the channel 2 abuts against the inner surface of the outer pipe 15, and the second fastening screw 3 in the channel 2 abuts against the outer surface of the through rod 27. The two fastening screws 3 in the channel 2 are coaxial (as shown in FIG. 33).

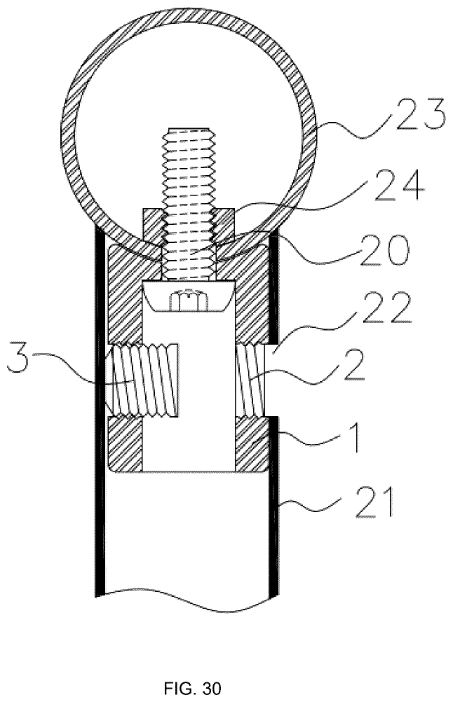

In the above, in the seventh application embodiment (as shown in FIGS. 30-32), the axial connector 1 has one end open and the other end closed (in this embodiment, the axial connector 1 is a pipe with one end closed and the other end open). A screw 20 is provided penetrating through the closed end, and the screw 20 extends out of the closed end from the body of the axial connector 1. The axial connector 1 is installed at the end of a to-be-connected pipe 21 (the axial connector 1 and the to-be-connected pipe 21 are coaxially provided; certainly, the to-be-connected pipe 21 may also be a profile, plate, etc., that can be coaxially installed with the axial connector 1). The to-be-connected pipe 21 is provided with an external counterbore 22 that is directly opposite to the channel to facilitate the fastening screw 3 entering the channel 2 (the fastening screw 3 passes through the external counterbore 22, is screwed into the channel 2, and abuts against the inner wall surface of the to-be-connected pipe). A connected pipe 23 is provided beside the to-be-connected pipe 21 (the connected pipe 23 is provided with a through hole for allowing the screw 20 to pass therethrough, the through hole is near the end of the connected pipe 23, and certainly, the connected pipe 23 may also be a profile, plate, etc. on which the nut 24 may be installed). The connected pipe (near the end position) is provided therein with the nut 24 that is connected and fastened to the screw 20.

When the connected pipe 23 is a circular pipe, the end of the to-be-connected pipe 21 is of an arc shape that fits with the connected pipe 23; and when the connected pipe 23 is a square pipe, the end of the to-be-connected pipe 21 is a flat surface that fits with the connected pipe 23.

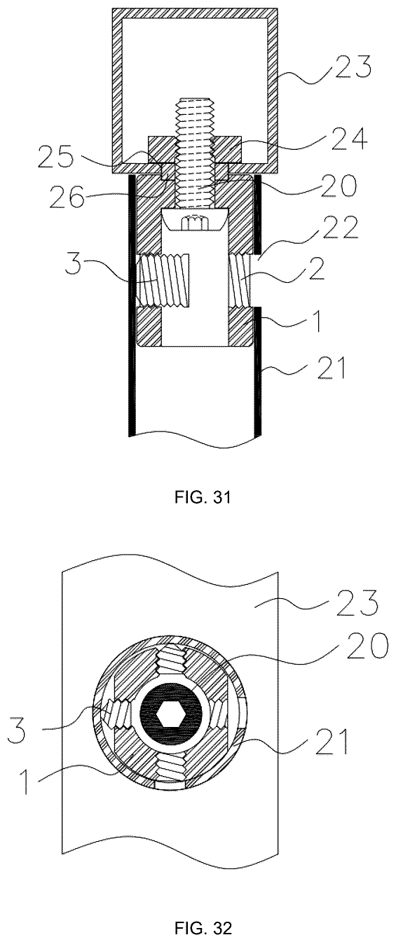

To improve the connection firmness (as shown in FIG. 31), non-circular grooves 25 are provided at corresponding positions of the contact surfaces of the connected pipe and to-be-connected pipe. A gasket 26 matching the shapes of the non-circular grooves 25 is provided in the non-circular grooves. By providing the non-circular grooves 25 and the gasket 26, the screw 20 can be prevented from slipping and rotating.

Similarly, in all the above embodiments, in order to prevent the outer pipe (including the external connecting pipe, the external connecting pipe and other pipe fittings used to be sleeved over the axial connector 1) from deforming due to being pushed by the fastening screw 3, the arc-shaped sheet 5 and/or the sealing ring 6 may be provided.

Through an axial connector 1 with simple structure, low cost, and standardized manufacturing and its specific installation method which uses a manner similar to internal expansion to achieve concealed fixing, the present disclosure greatly improves the convenience, firmness, reliability, and aesthetics of pipe fitting connections. Furthermore, it overcomes the drawback that any previous connection methods cannot overcome, i.e., the pipe fittings with irregularly-shaped cross sections are connected only by flanges. In particular, the simple combination of multiple connectors enables connection of multi-way pipe fittings. The characteristic that it may be repeatedly disassembled and assembled provides great convenience for product assembly, packaging, transportation, installation, use, and recycling, making it a superior environmentally-friendly resource-saving solution.

Finally, it should be noted that the above embodiments are only used to illustrate the technical solutions of the present disclosure but not to limit them, although the present disclosure has been described in detail with reference to preferred embodiments, those ordinarily skilled in the art should understand that modifications may still be made to the specific implementation of the present disclosure or equivalent substitutions may be made to some technical features without departing from the spirit of the technical solutions of the present disclosure, and all such modifications and substitutions should fall within the scope of the technical solutions claimed in the present disclosure.

1. A concealed connector structure, comprising an axial connector and at least one channel each capable of being threadedly connected with a fastening screw and provided on the axial connector, wherein the channel extends radially through the axial connector, and an axis line of the channel is provided perpendicular to or inclined to an axis line of the axial connector, so as to allow the fastening screw to be inserted through a first end of the channel and extend out from a second end of the channel.

2. The concealed connector structure according to claim 1, wherein a cross-section of the axial connector is same in an entire length direction, and the cross-section is circular, square or elliptical, or the axial connector has two or more different cross-sections or dimensions in the entire length direction, and the cross-sections are circular, square or elliptical.

3. The concealed connector structure according to claim 1, wherein the axial connector is a hollow rod body, a wall body of a side of the hollow rod body is provided with at least one threaded hole and a wall body of a side opposite to the at least one threaded hole is provided with at least one through hole each configured for allowing the fastening screw to pass therethrough, and the at least one threaded hole and the at least one through hole constitute the at least one channel extending through the axial connector; or the axial connector is a hollow rod body, wall bodies of two sides of the hollow rod body are provided with identical threaded holes, any two corresponding threaded holes of the wall bodies of the two sides are coaxial and constitute one of the at least one channel extending through the axial connector; or the axial connector is a solid rod body, the solid rod body is provided with at least one threaded hole or at least one threaded countersunk hole extending through the axial connector, and the at least one threaded hole or the at least one threaded countersunk hole constitute the at least one channel extending through the axial connector.

4. The concealed connector structure according to claim 1, wherein the axial connector is provided with several groups of channels in a circumferential direction, and/or the axial connector is provided with several groups of channels in an axial direction.

5. The concealed connector structure according to claim 1, wherein two ends of the axial connector are provided with channels, wherein in a first application, fastening screws are threadedly connected inside the two channels; external connecting pipes are respectively sleeved over the two ends of the axial connector, and the fastening screws extend out from second ends of the channels and abut against inner wall surfaces of the external connecting pipes.

6. The concealed connector structure according to claim 5, wherein an arc-shaped sheet is provided between the inner wall surface of the external connecting pipe and an outer peripheral surface of the axial connector, and an end of the fastening screw extending out from the second end of the channel abuts against an inner wall surface of the arc-shaped sheet, and an outer peripheral surface of the arc-shaped sheet fits with the inner wall surface of the external connecting pipe; or a sealing ring is provided between the outer peripheral surface of the arc-shaped sheet and the inner wall surface of the external connecting pipe.

7. The concealed connector structure according to claim 1, wherein in a second application, external connecting pipes sleeved over two ends of the axial connector are provided at an internal, and the axial connector is provided with at least one intermediate threaded hole located between the two external connecting pipes, at least one stud is inserted into the at least one intermediate threaded hole, and the at least one stud passes through at least one through hole of a second outer pipe located above the axial connector.

8. The concealed connector structure according to claim 1, wherein in a third application, an outer pipe is sleeved over an outer periphery of the axial connector, the outer pipe is provided with at least one counterbore, the at least one counterbore is directly opposite to the first end or the second end of the at least one channel provided on the axial connector, but no counterbore is provided at a position directly opposite to the fastening screw that extends out from the second end of the at least one channel.

9. The concealed connector structure according to claim 1, wherein the axial connector has one end open and the other end closed, and a screw is provided penetrating through the closed end, wherein in a fourth application, the axial connector is installed at an end of a to-be-connected pipe, the to-be-connected pipe is provided with an external counterbore directly opposite to the channel, to facilitating the fastening screw entering the channel, a connected pipe with a through hole configured for allowing the screw to pass therethrough is provided beside the to-be-connected pipe, and a nut configured for fastening the screw is provided inside the connected pipe.

10. A method of using the concealed connector structure according to claim 5, comprising: pre-screwing fastening screws into the channels at two ends of the axial connector, with the fastening screws not protruding from the second ends of the channels, sleeving two external connecting pipes over the two ends of the axial connector respectively, inserting an internal hexogen wrench into counterbores of the external connecting pipes and the channels of the axial connector, and rotating the fastening screws to make the fastening screws extend out from the second ends of the channels and abut against inner wall surfaces of the external connecting pipes, so as to achieve fastening of the axial connector to the external connecting pipes and realizing axial extension connection of the two external connecting pipes.
